(19) United States
(12) Patent Application Publication
(10) Pub. No.: US 2007/0063928 A1
(43) Pub. Date: Mar. 22, 2007

(54) Plasma display panel and method of driving plasma display panel

(75) Inventors: Seung-Hyun Son, Suwon-si (KR); Young-Mo Kim, Suwon-si (KR); Hidekazu Hatanaka, Suwon-si (KR); Sang-Hun Jang, Suwon-si (KR); Ho-Nyeon Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/433,525

(22) Filed: May 15, 2006

(30) Foreign Application Priority Data
May 16, 2005 (KR) 2005-40552

(51) Int. Cl. G09G 3/28

(52) U.S. Cl. 345/67

(57) ABSTRACT

A plasma display panel includes a plurality of sustain electrode pairs, each of the sustain electrode pairs including an X electrode and a Y electrode; and a plurality of address electrodes crossing the sustain electrode pairs; wherein each of the address electrodes includes a main section having a first width, and extended-width portions having a second width greater than the first width, the extended-width portions being formed where the address electrode crosses either the X electrodes or the Y electrodes of the sustain electrode pairs.

### CROSS-REFERENCE TO RELATED APPLICATION

This application claims the benefit of Korean Application No. 2005-40552 filed on May 16, 2005 in the Korean Intellectual Property Office, the disclosure of which is incorporated herein by reference in its entirety.

### BACKGROUND OF THE INVENTION

1. Field of the Invention

An aspect of the invention relates to a plasma display panel, and more particularly to a plasma display panel that can reduce a capacitance between adjacent address electrodes and can increase transmission of light by alternately arranging the address electrodes.

2. Description of the Related Art

Due to their characteristics of high brightness and a large viewing angle, the use of plasma display panels that display images using an electric discharge has been rapidly increasing. A plasma display panel emits visible light when a phosphor material is excited by ultraviolet rays generated by gas discharge which occurs between electrodes when a direct or alternating current voltage is applied to the electrodes.

FIGS. 1 and 2 show a structure of a conventional transmission-type plasma display panel. FIG. 1 is a partially cutaway exploded perspective view of a typical conventional transmission-type plasma display panel, and FIG. 2 is a schematic plan view of electrodes of the plasma display panel of FIG. 1.

Referring to FIG. 1, the conventional transmission-type plasma display panel includes a rear panel 10 and a transparent front panel 20 facing the rear panel 10. A plurality of sustain electrode pairs 13 and 14 are arranged on the rear panel 10, and the sustain electrode pairs 13 and 14 are covered by a first dielectric layer 16. A protection film 19 is formed on an upper surface of the first dielectric layer 16.

A plurality of address electrodes 22 crossing the sustain electrode pairs 13 and 14 are formed on a lower surface of the transparent front panel 20, and the address electrodes 22 are covered by a second dielectric layer 26 formed on a lower surface of the transparent front panel 20. A plurality of barrier ribs 28 that define discharge cells 30 are disposed at regular predetermined intervals on a lower surface of the second dielectric layer 26, and a phosphor layer 29 is formed on the lower surface of the second dielectric layer 26 and side walls of the barrier ribs 28, that is, on surfaces of the discharge cells defined by the barrier ribs 28. Each of the discharge cells 30 contains a plurality of pixels. Each of the pixels is a space defined by the crossing of one address electrode 22 and one sustain electrode pair 13 and 14.

FIG. 2 is a schematic plan view of address electrodes and sustain electrode pairs of the conventional transmission-type plasma display panel of FIG. 1.

Referring to FIG. 2, the address electrodes 22 are formed along the discharge cells 30 defined by the barrier ribs 28, and the sustain electrode pairs 13 and 14, each composed of an X electrode 13 and a Y electrode 14, are perpendicular to the address electrodes 22. Typically, address discharges are generated between the address electrodes 22 and the Y electrodes 14. That is, to generate an address discharge, an address waveform is applied only to the Y electrodes 14. FIG. 3 shows address waveforms for performing a writing operation in each pixel of the plasma display panel having the structure shown in FIG. 1.

In FIG. 3, only the Y electrodes 14 are scan electrodes. Each of the Y electrodes 14 of the sustain electrode pairs 13 and 14 is scanned line by line to generate an address discharge between the Y electrode 14 and the address electrodes 22. Accordingly, an address waveform is sequentially applied to each of the Y electrodes 14 of the sustain electrode pairs 13 and 14 to generate address discharges between the address electrodes 22 and the Y electrodes 14 crossing the address electrodes 22.

However, in the conventional transmission-type plasma display panel, the address electrodes 22 interfere with the transmission of visible light through the transparent front panel 20 because the address electrodes 22 are located in the pathway of the visible light. Accordingly, to increase the transmission of the visible light, the address electrodes 22 are formed of indium tin oxide (ITO), and are formed to have a narrow width. However, the address electrodes 22 must also be wide enough where they cross the Y electrodes 14 to enable generation of address discharges between the address electrodes 22 and the Y electrodes 14. Therefore, the narrow width of the address electrodes 22 is a disadvantage in this regard.

### SUMMARY OF THE INVENTION

An aspect of the invention provides a plasma display panel having an address electrode structure that has a large crossing portion between an address electrode and a sustain electrode and prevents the reduction of light transmittance despite the address electrode being located on a front substrate through which the light is transmitted.

According to an aspect of the invention, a plasma display panel includes a rear substrate; a front substrate facing the rear substrate and coupled to the rear substrate; a plurality of sustain electrode pairs, each of the sustain electrode pairs including an X electrode and a Y electrode, formed in a predetermined pattern on a front surface of the rear substrate facing the front substrate; a first dielectric layer formed on the front surface of the rear substrate to cover the sustain electrode pairs; a protection film formed on a front surface of the first dielectric layer facing the front substrate; a plurality of address electrodes formed on a rear surface of the front substrate facing the rear substrate so that the address electrodes cross the sustain electrode pairs; a second dielectric layer formed on the rear surface of the front substrate to cover the address electrodes; a plurality of barrier ribs spaced apart from each other at regular predetermined intervals on a rear surface of the second dielectric layer facing the rear substrate to define a plurality of discharge cells; and a phosphor layer formed on surfaces of the discharge cells defined by the barrier ribs, wherein each of the address electrodes includes a main section having a first width, and extended-width portions having a second width greater than the first width, the extended-width portions being formed where the address electrode crosses either the X electrodes or the Y electrodes of the sustain electrode pairs.

Each of the address electrodes may extend along a respective one of the discharge cells. The extended-width portions of some of the address electrodes may be formed where the some of the address electrodes cross the X electrodes in respective ones of the discharge cells. The extended-width portions of remaining ones of the address electrodes may be formed where the remaining ones of the address electrodes cross the Y electrodes in respective ones of the discharge cells.

The address electrodes may include a plurality of groups of two adjacent address electrodes. The extended-width portions of a first address electrode of the two adjacent address electrodes may be formed where the first address electrode crosses the X electrodes, and the extended-width portions of a second address electrode of the two adjacent address electrodes may be formed where the second address electrode crosses the Y electrodes.

The X electrodes and the Y electrodes may be scan electrodes.

The X electrodes and the Y electrodes may alternately generate address discharges with the address electrodes.

The extended-width portions are formed by flaps protruding from both sides of the main sections of the address electrodes.

According to another aspect of the invention, a method of driving a plasma display panel having the structure described above includes applying a same address waveform to the X electrodes and the Y electrodes.

The same address waveform may be alternately applied to the X electrodes and the Y electrodes.

The front substrate may be transparent.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments of the invention, taken in conjunction with the accompanying drawings of which:

FIG. 1 is a partially cutaway exploded perspective view of a typical conventional transmission-type plasma display panel;

FIG. 2 is a schematic plan view of electrodes of the plasma display panel of FIG. 1;

FIG. 3 shows address waveforms for the plasma display panel of FIG. 1;

FIG. 4 is a partially cutaway exploded perspective view of a plasma display panel according to an embodiment of the invention;

FIG. 5 is an exploded perspective view showing the relationship between electrodes of the plasma display panel of FIG. 4 according to an embodiment of the invention;

FIG. 6 is a plan view showing the relationship between electrodes of the plasma display panel of FIG. 4 according to an embodiment of the invention;

FIG. 7 shows address waveforms for the plasma display panel of FIG. 4 according to an embodiment of the invention;

FIG. 8A is a vertical cross-sectional view taken along a line I-I′ of the plasma display panel of FIG. 4 according to an embodiment of the invention; and

FIG. 8B is a vertical cross-sectional view taken along a line II-II′ of the plasma display panel of FIG. 4 according to an embodiment of the invention.

### DETAILED DESCRIPTION OF THE INVENTION

Reference will now be made in detail to embodiments of the invention, examples of which are shown in the accompanying drawings, wherein like reference numerals refer to like elements throughout. The embodiments are described below in order to explain the invention by referring to the figures.

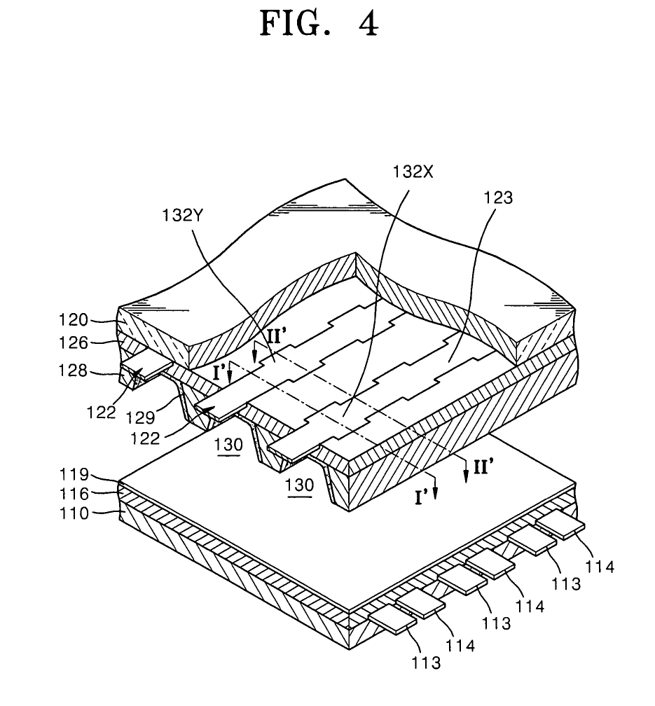

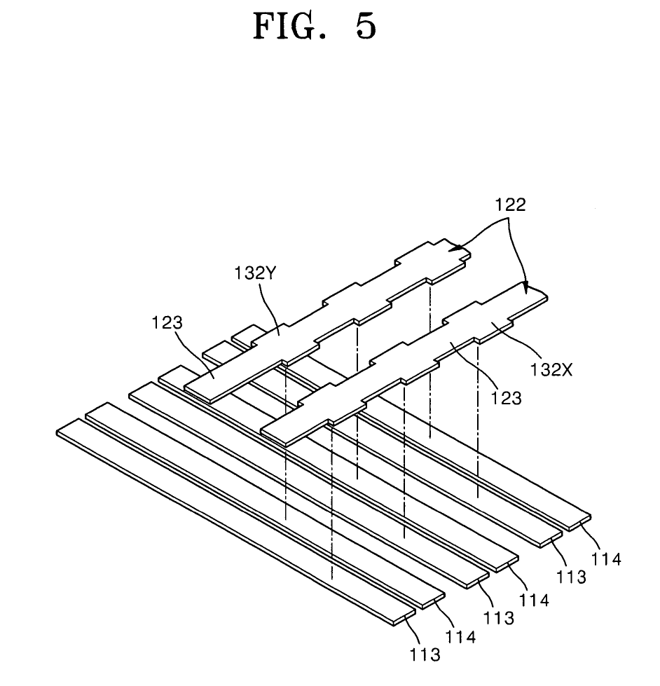

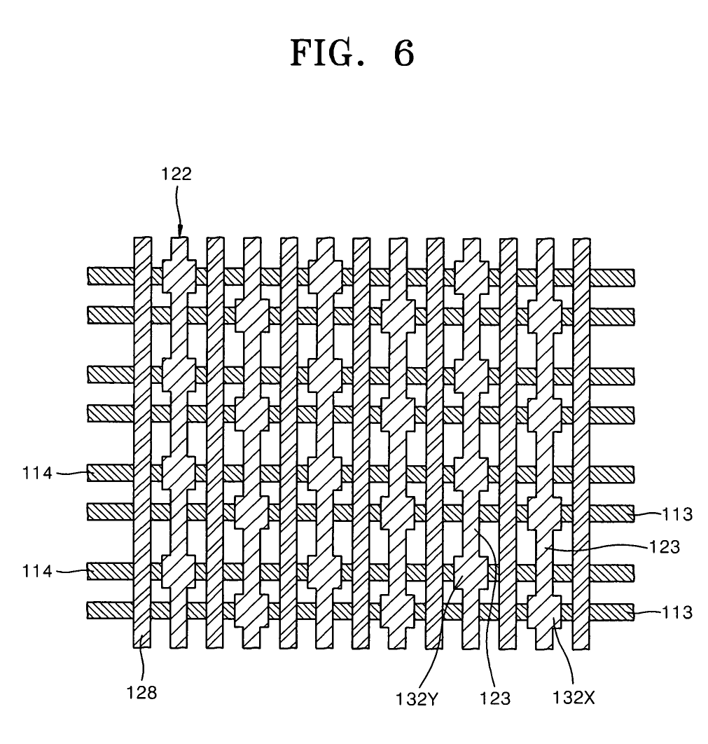

FIG. 4 is a partially cutaway exploded perspective view of a plasma display panel according to an embodiment of the invention, FIG. 5 is an exploded perspective view showing the relationship of electrodes of the plasma display panel of FIG. 4 according to an embodiment of the invention, and FIG. 6 is a plan view illustrating the relationship of electrodes of the plasma display panel of FIG. 4 according to an embodiment of the invention.

Referring to FIG. 4, the plasma display panel according to an embodiment of the invention includes a rear substrate 110; a plurality of sustain electrode pairs 113 and 114 formed on the rear substrate 110, each sustain electrode pair 113 and 114 including an X electrode 113 and a Y electrode 114 each having a stripe shape; a first dielectric layer 116 formed on an upper surface of the rear substrate 110 to cover the sustain electrode pairs 113 and 114; and a protection film 119 formed on an upper surface of the first dielectric layer 116.

The plasma display panel also includes a transparent front substrate 120 facing the rear substrate 110 and coupled to the rear substrate 110; a plurality of address electrodes 122 having a predetermined pattern perpendicularly crossing the sustain electrode pairs 113 and 114 on a lower surface of the transparent front substrate 120; a second dielectric layer 126 formed on a lower surface of the transparent front substrate 120 to cover the address electrodes 122; a plurality of barrier ribs 128 formed on a lower surface of the second dielectric layer 126 spaced apart from each other at regular predetermined intervals to define a plurality of discharge cells 130 and to prevent electrical and optical interference between the discharge cells 130; and a phosphor layer 129 formed on the lower surface of the second dielectric layer 126 and side walls of the barrier ribs 28, that is, on surfaces of the discharge cells 130 defined by the barrier ribs 128. Each of the discharge cells 130 contains a plurality of sub-pixels. Each of the sub-pixels is a space defined by the crossing of one address electrode 122 and one sustain electrode pair 113 and 114.

As shown in FIG. 4, the protection film 119 is formed on an upper surface of the first dielectric layer 116. The protection film 119 prevents the first dielectric layer 116 and the sustain electrode pairs 113 and 114 composed of the X electrodes 113 and the Y electrodes 114 from being damaged by sputtering of plasma particles, and reduces discharge and sustain voltages by generating secondary electrons. The protection film 119 may be formed on the upper surface of the first dielectric layer 116 by coating MgO to a thickness of 0.2 to 2 μm. The first dielectric layer 116 may be formed on the upper surface of the rear substrate 110 by coating a white dielectric material to a thickness of 15 to 40 μm. However, it is understood that other thicknesses and materials can be used.

The rear substrate 110 may be formed of a material that can be easily molded because the rear substrate 110 does not need to be transparent. For example, the rear substrate 110 may be molded using a metallic material or a ceramic that can be processed. However, other materials can be used, and the materials need not be easily molded in all aspects.

The transparent front substrate 120 may be mainly formed of glass so that light can be transmitted therethrough. Also, the discharge cells 130 are filled with a discharge gas containing Ne gas, Xe gas, or a mixture of these gases, and red R, green G, and blue B phosphor layers 129 having predetermined thicknesses are coated on the lower surface of the second dielectric layer 126 and side walls of the barrier ribs 128, that is, on surfaces of the discharge cells 130 defined by the barrier ribs 128.

The address electrodes 122 disposed on the lower surface of the transparent front substrate 120 may be formed of ITO which is a transparent conductive material. However, the sustain electrode pairs 113 and 114 composed of the X electrodes 113 and the Y electrodes 114 formed on the upper surface of the rear substrate 110 may be formed of any suitable conductive material because the sustain electrode pairs 113 and 114 do not need to be transparent.

The address electrodes 122, as described above, are formed of ITO which is a transparent conductive material having a relatively high resistance. Therefore, to reduce a line resistance of the address electrodes 122, a bus electrode (not shown) formed of a highly conductive metal may be connected to each of the address electrodes 122. The bus electrode is also covered by the second dielectric layer 126 together with the address electrodes 122. A bridge (not shown) is included between the bus electrodes and the address electrodes 122 to make an electrical connection therebetween. A plurality of bridges may be provided along the length of the bus electrode at regular predetermined intervals. The bus electrodes may be disposed at locations corresponding to the barrier ribs 128 so that the bus electrodes do not interfere with the transmission of visible light through the transparent front substrate 120.

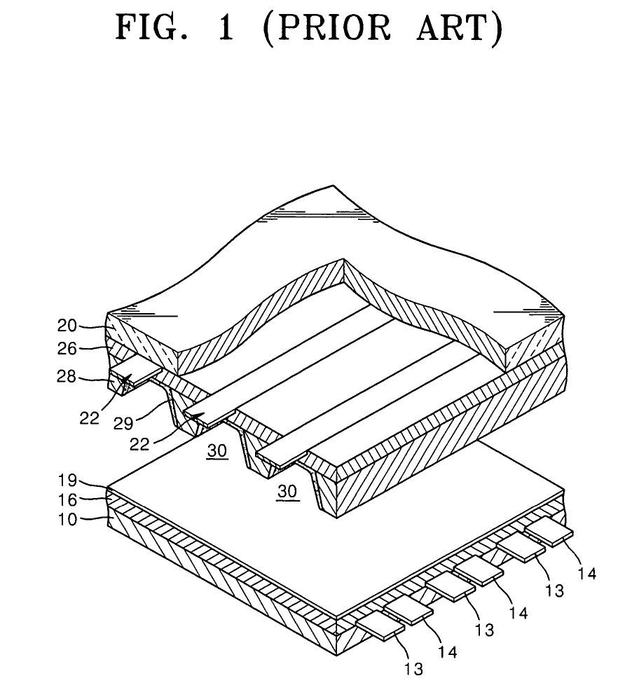

The address electrodes 122 in the plasma display panel according to an embodiment of the invention include extended-width portions 132X and 132Y that are wider than main sections 123 of the address electrodes 122 at predetermined locations with respect to the main sections 123 of the address electrodes 122. That is, the address electrodes 122 in the plasma display panel according to an embodiment of the invention are not uniform-width electrodes like the address electrodes 22 in the plasma display panel shown in FIG. 1.

The extended-width portions 132X and 132Y of the address electrodes 122 are formed at locations where the address electrodes 122 cross the X electrodes 113 and the Y electrodes 114, respectively, of the sustain electrode pairs 113 and 114. FIG. 5 is an exploded perspective view showing the relationship between the address electrodes 122 and the sustain electrode pairs 113 and 114 according to an embodiment of the invention. Referring to FIG. 5, one address electrode 122 located at a right side of two adjacent address electrodes 122 has extended-width portions 132X where the address electrode 122 crosses the X electrodes 113, and another address electrode 122 located at a left side of the two adjacent address electrodes 122 has extended-width portions 132Y where the address electrode 122 crosses the Y electrodes 114. While the shown extended-width portions 132X, 132Y have a same shape and are rectangular, it is understood that other shapes can be used and/or be curved, and that the shapes need not be uniform in all aspects.

One extended-width portion 132X or one extended-width portion 132Y is formed with respect to one of the sustain electrode pairs 113 and 114 in each of the sub-pixels, i.e., in the space defined by the crossing of one address electrode 122 and one sustain electrode pair 113 and 114. That is, either one extended-width portion 132X or one extended-width portion 132Y is located in each sub-pixel. Referring to FIG. 5, the address electrode 122 located on the right-hand side has extended-width portions 132X where the address electrode 122 crosses the X electrodes 113 of the sustain electrode pairs 113 and 114, but the main section 123 having a narrower width than the extended-width portions 132X is maintained in locations other than where the address electrode 122 crosses the X electrodes 113. Accordingly, the address electrode 122 located on the right-hand side has the main section 123 where the address electrode 122 crosses the Y electrodes 114 of the sustain electrode pairs 113 and 114, and has the extended-width portions 132X where the address electrode 122 crosses the X electrodes 113 of the sustain electrode pairs 113 and 114. Therefore, the extended-width portions 132X are discontinuously formed at the locations where the address electrode 122 crosses the sustain electrode pairs 113 and 114.

On the other hand, the address electrode 122 located on the left-hand side in FIG. 5 has extended-width portions 132Y only where the address electrode 122 crosses the Y electrodes 114 of the sustain electrode pairs 113 and 114. Locations where the address electrode 122 crosses the X electrodes 113 of the sustain electrode pairs 113 and 114 do not have extended-width portions 132Y. In these locations, the main section 123 having a narrower width than the extended-width portions 132Y is maintained.

The main section 123 and the extended-width portions 132X or 132Y are formed in one piece.

As shown in FIG. 5, the extended-width portions 132X and 132Y are formed where the address electrodes 122 cross the sustain electrode pairs 113 and 114 because one of the two adjacent address electrodes 122 has the extended-width portions 132X where the address electrode 122 crosses the X electrodes 113, and the other one of the two adjacent address electrodes 122 has the extended-width portions 132Y where the address electrode 122 crosses the Y electrodes 114. In FIG. 5, the X electrodes 113 and the Y electrodes 114 of the sustain electrode pairs 113 and 114 corresponding to the extended-width portions 132X and 132Y are indicated by dash-dot lines.

Referring to FIG. 6, an overall relationship between the address electrodes 122 and the sustain electrode pairs 113 and 114 is shown. FIG. 6 is a plan view of the address electrodes 122 and the sustain electrode pairs 113 and 114 viewed from the transparent front substrate 120 according to an embodiment of the invention.

Referring to FIG. 6, each of the address electrodes 122 is located in one of the discharge cells 130 defined by the barrier ribs 128, and, as shown in FIG. 5, the address electrodes 122 cross the sustain electrode pairs 113 and 114 composed of the X electrodes 113 and the Y electrodes 114. In FIG. 6, portions of the sustain electrode pairs 113 and 114 are hidden by the address electrodes 122 because the sustain electrode pairs 113 and 114 are located below the address electrodes 122.

As described above with reference to FIG. 5, one of the two adjacent address electrodes 122 has extended-width portions 132X crossing the X electrodes 113, and the other one of the two adjacent address electrodes 122 has extended-width portions 132Y crossing the Y electrodes 114. Accordingly, each of the address electrodes 122 has an extended-width portion at every other crossing of the X electrodes 113 and the Y electrodes 114 of the sustain electrode pairs 113 and 114, and the extended-width portions 132X and 132Y of the two adjacent address electrodes 122 are formed alternately.

The address electrodes 122 of the plasma display panel having the above structure according to an embodiment of the invention can achieve the two contradictory requirements that the address electrodes 122 must be as narrow as possible to reduce interference with transmission of visible light through the transparent front substrate 120 because the address electrodes 122 are located on the transparent front substrate 120, i.e., in the pathway of the visible light, and the portions of the address electrodes 122 where they cross the X electrodes 113 and the Y electrodes 114 must be wide enough to enable generation of address discharges between the address electrodes 122 and the X electrodes 113 and between the address electrodes 122 and the Y electrodes 114. That is, the address electrodes 122 according to an embodiment of the invention do not have a large width in all portions thereof, but have the extended-width portions 132X and 132Y formed only at locations where the address electrodes 122 cross the X electrodes 113 and the Y electrodes 114, thereby reducing interference with the transmission of the visible light caused by the address electrodes 122. The extended-width portions 132X and 132Y are formed by flaps protruding from both sides of the main sections 123 of the address electrodes 122.

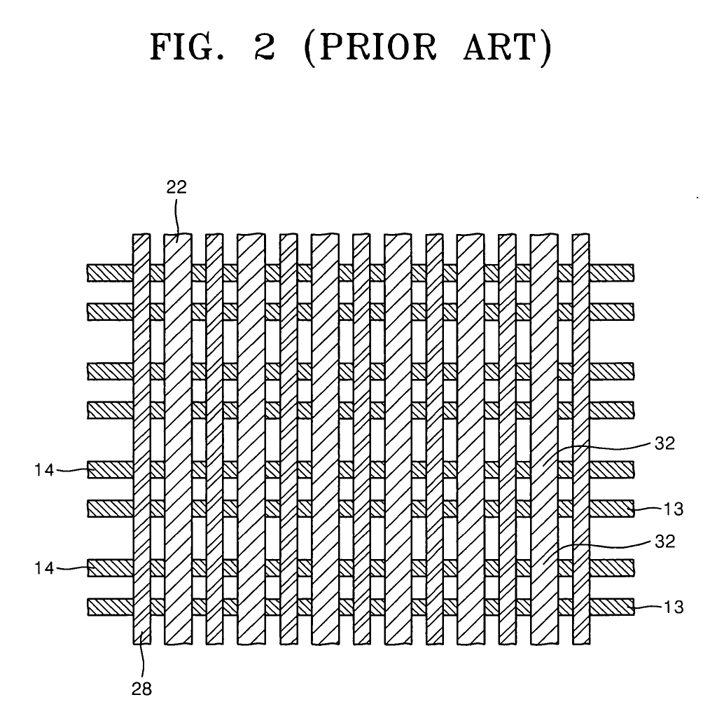

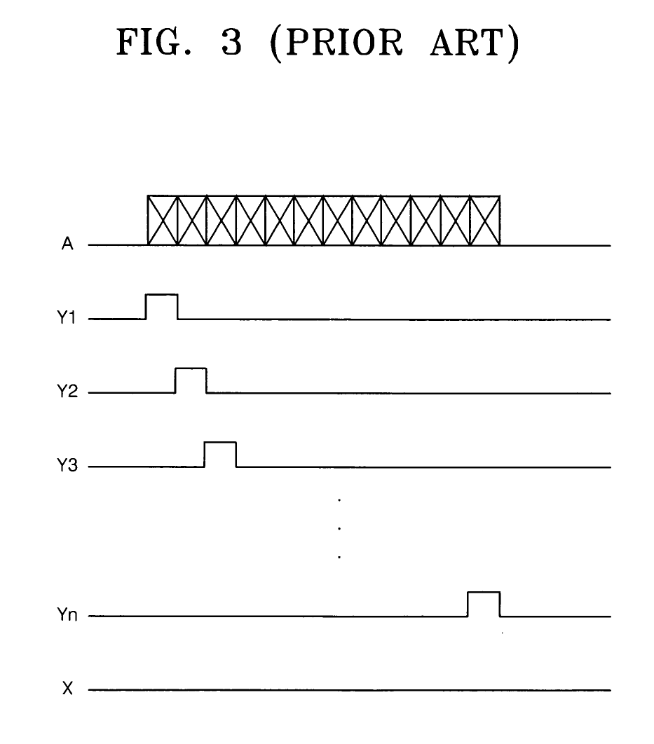

Unlike in a conventional plasma display panel as shown in FIGS. 1-3 in which only a Y electrode of a sustain electrode pair composed of an X electrode and a Y electrode is a scan electrode and a sustain waveform is applied only to the Y electrode when a sustain discharge is generated, in the plasma display panel according to an embodiment of the invention, both the X electrode 113 and the Y electrode 114 that constitute a sustain electrode pair 113 and 114 are scan electrodes and alternately generate address discharges with the address electrodes 122. However, it is understood that the conventional method can be used with the plasma display panel shown in FIGS. 4-6 in other aspects of the invention.

Driving of a transmission-type plasma display panel having the above configuration is divided into address discharge driving and sustain discharge driving. During the address discharge driving, address discharges are generated between the address electrodes 122 disposed on the transparent front substrate 120 and the X electrodes 113 and the Y electrodes 114 that constitute the sustain electrode pairs 113 and 114 disposed on the rear substrate 110, and at this time, wall charges are generated on surfaces of the discharge cells 130.

One difference between the plasma display panel according to an embodiment of the invention and a conventional plasma display panel is that both the X electrodes 113 and the Y electrodes 114 in the plasma display panel according to an embodiment of the invention generate address discharges with the address electrodes 122. In the case of the conventional plasma display panel as shown in FIGS. 1-3, an address waveform is applied to only one sustain electrode (typically a Y electrode) of the sustain electrode pair, and an address discharge is generated between the one sustain electrode and an address electrode. However, in the invention, an address waveform is applied to both the X electrodes 113 and the Y electrodes 114 of the sustain electrode pairs 113 and 114.

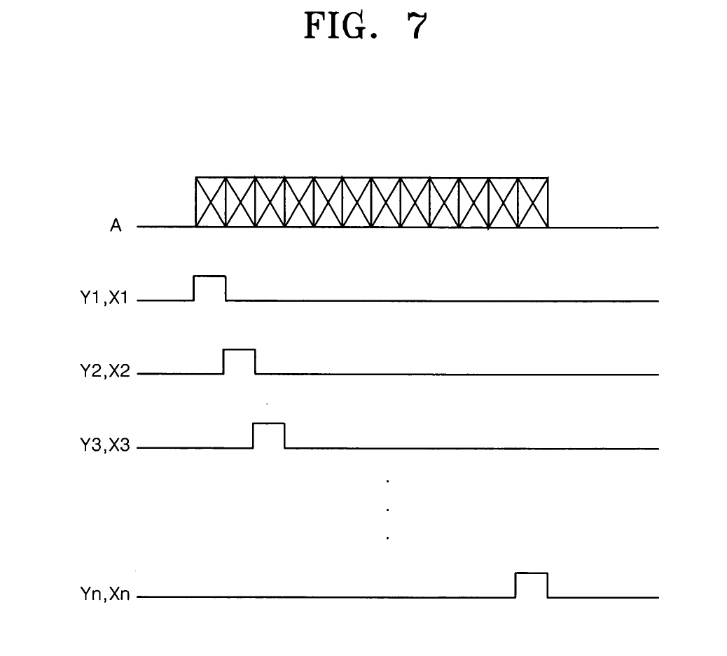

FIG. 7 shows address waveforms applied to the address electrodes 122 and the sustain electrode pairs 113 and 114 of the plasma display panel shown in FIG. 4 according to an embodiment of the invention.

As shown in FIG. 7, an identical address waveform is applied to the X electrodes 113 and the Y electrodes 114 of the sustain electrode pairs 113 and 114. In FIG. 7, to indicate the sequence of applying the address waveform to the X electrode 113 and the Y electrode 114 disposed in one of a plurality of sub-pixels, the address waveforms are numbered (Y1, X1), (Y2, X2), . . . (Yn, Xn), etc. Thus, it can be seen that in a plasma display panel according to the invention, an identical address waveform is applied to the X electrode 113 and the Y electrode 114 of a sustain electrode pair 113 and 114 in one sub-pixel.

The address waveform is sequentially applied to the sustain electrode pairs 113 and 114 to sequentially scan all of the sustain electrode pairs 113 and 114 that serve as scan electrodes. Accordingly, as shown in FIG. 7, while a predetermined address waveform A is sequentially applied to the address electrodes 122, an identical address waveform is sequentially applied to the X electrode 113 and the Y electrode 114 of each sustain electrode pair 113 and 114 sequentially for all of the sustain electrode pairs 113 and 114.

In this process, an address waveform is alternately applied to the X electrodes 113 and the Y electrodes 114, and address discharges are generated between the X electrodes 113 and the address electrodes 122, and between the Y electrodes 114 and the address electrodes 122.

A sustain discharge is generated due to a potential difference between the X electrodes 113 and the Y electrodes 114 of the sustain electrode pairs 113 and 114 located in the discharge cells 130 where wall charges are generated by the address discharges. At this time, visible light is emitted from the phosphor layer 129 which is excited by ultraviolet rays generated from the discharge gas when the sustain discharge is generated in the discharge cells 130, and the visible light forms an image on the plasma display panel after passing through the phosphor layer 129 and the transparent front substrate 120.

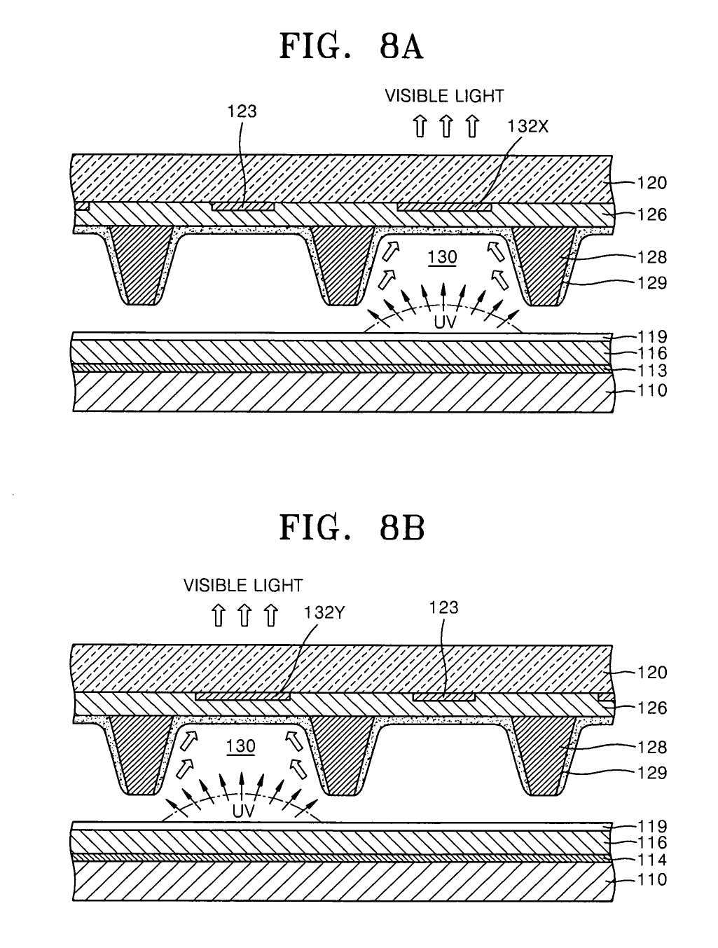

Discharge phenomena in the discharge cells 130 will now be described with reference to FIGS. 8A and 8B. FIGS. 8A and 8B are vertical cross-sectional views respectively taken along lines I-I′ and II-II′ of the plasma display panel of FIG. 4 according to an embodiment of the invention.

Referring to FIG. 8A, a portion of an address electrode 122 included in a discharge cell 130 shown on the left-hand side of FIG. 8A corresponds to a main section 123, and a portion of an address electrode 122 included in a discharge cell 130 shown on the right-hand side of FIG. 8A corresponds to an extended-width portion 132X. That is, the extended-width portion 132X of the address electrode 122 in the discharge cell 130 on the right-hand side of FIG. 8A corresponds to a crossing portion where the address electrode 122 crosses an X electrode 113 of a sustain electrode pair 113 and 114.

An address waveform is applied to the X electrode 113 of the sustain electrode pair 113 and 114 to generate an address discharge between the extended-width portion 132X of the address electrode 122 and the X electrode 113, and immediately after that, a sustain discharge is generated between the X electrode 113 and the Y electrode 114 (not shown in FIG. 8A) of the sustain electrode pair 113 and 114.

Referring to FIG. 8B, a portion of an address electrode 122 included in a discharge cell 130 shown on the left-hand side of FIG. 8A corresponds to an extended-width portion 132Y, and a portion of an address electrode 122 included in a discharge cell 130 shown on the right-hand side of FIG. 8B corresponds to a main section 123. That is, the extended-width portion 132Y of the address electrode 122 in the discharge cell 130 on the left-hand side of FIG. 8B corresponds to a crossing portion where the address electrode 122 crosses a Y electrode 114 of a sustain electrode pair 113 and 114.

An address waveform is applied to the Y electrode 114 of the sustain electrode pair 113 and 114 to generate an address discharge between the extended-width portion 132Y of the address electrode 122 and the Y electrode 114, and immediately after that, a sustain discharge is generated between the X electrode 113 (not shown in FIG. 8B) and the Y electrode 114 of the sustain electrode pair 113 and 114.

Thus, as shown in FIGS. 8A and 8B, an address waveform is alternately applied to the X electrodes 113 and the Y electrodes 114 of the sustain electrode pairs 113 and 114 to generate address discharges between the X electrodes 113 and the extended-width portions 132X of the address electrodes 122, and between the Y electrodes 114 and the extended-width portions 132Y of the address electrodes 122, thereby driving the plasma display panel.

As described above, according to an aspect of the invention, sufficient address discharges can be generated even though the width of portions of the address electrodes has been reduced, and accordingly, interference with the transmission of visible light due to the address electrodes can be reduced.

Also, according to an aspect of the invention, a capacitance between adjacent address electrodes can be reduced. Therefore, signal interference between adjacent address electrodes can be prevented and distortion of signal waveforms can be prevented by reducing resistance-capacitance (RC) delays in address lines, thereby increasing image quality.

Although several embodiments of the invention have been shown and described, it would be appreciated by those of ordinary skill in the art that changes may be made in these embodiments without departing from the principles and spirit of the invention, the scope of which is defined in the claims and their equivalents.

What is claimed is:

1. A plasma display panel comprising:
a rear substrate;
a front substrate facing the rear substrate and coupled to the rear substrate;
a plurality of sustain electrode pairs, each of the sustain electrode pairs comprising an X electrode and a Y electrode, formed in a predetermined pattern on a front surface of the rear substrate facing the front substrate;
a first dielectric layer formed on the front surface of the rear substrate to cover the sustain electrode pairs;
a protection film formed on a front surface of the first dielectric layer facing the front substrate;
a plurality of address electrodes formed on a rear surface of the front substrate facing the rear substrate so that the address electrodes cross the sustain electrode pairs;
a second dielectric layer formed on the rear surface of the front substrate to cover the address electrodes;
a plurality of barrier ribs spaced apart from each other at regular predetermined intervals on a rear surface of the second dielectric layer facing the rear substrate to define a plurality of discharge cells; and
a phosphor layer formed on surfaces of the discharge cells defined by the barrier ribs,
wherein each of the address electrodes comprises a main section having a first width, and extended-width portions having a second width greater than the first width, the extended-width portions being formed where the address electrode crosses either the X electrodes or the Y electrodes of the sustain electrode pairs.

2. The plasma display panel of claim 1, wherein each of the address electrodes extends along a respective one of the discharge cells;
wherein the extended-width portions of some of the address electrodes are formed where the some of the address electrodes cross the X electrodes in respective ones of the discharge cells; and
wherein the extended-width portions of remaining ones of the address electrodes are formed where the remaining ones of the address electrodes cross the Y electrodes in respective ones of the discharge cells.

3. The plasma display panel of claim 2, wherein the address electrodes comprise a plurality of groups of two adjacent address electrodes;
wherein the extended-width portions of a first address electrode of the two adjacent address electrodes are formed where the first address electrode crosses the X electrodes; and
wherein the extended-width portions of a second address electrode of the two adjacent address electrodes are formed where the second address electrode crosses the Y electrodes.

4. The plasma display panel of claim 1, wherein the X electrodes and the Y electrodes are scan electrodes.

5. The plasma display panel of claim 4, wherein the X electrodes and the Y electrodes alternately generate address discharges with the address electrodes.

6. The plasma display panel of claim 1, wherein the extended-width portions are formed by flaps protruding from both sides of the main sections of the address electrodes.

7. A method of driving the plasma display panel of claim 1, comprising applying a same address waveform to the X electrodes and the Y electrodes.

8. The method of claim 7, wherein the same address waveform is alternately applied to the X electrodes and the Y electrodes.

9. The method of claim 7, wherein the front substrate is transparent.
